(19) United States
(12) Patent Application Publication
(10) Pub. No.: US 2024/0117509 A1
(43) Pub. Date: Apr. 11, 2024

(54) ELECTROLYSIS PLATE FOR HYDROGEN PROCUTION AND METHOD FOR PRODUCING AN ELECTROLYSIS PLATE

(71) Applicant: Schaeffler Technologies AG & Co. KG, Herzogenaurach (DE)

(72) Inventors: Ramon Jurjanz, Buttenheim (DE); Benedikt Wehner, Fladungen (DE); Marcel Ehmann, Erlangen (DE); Torsten Keller, Hessdorf (DE); Florian Doerrfuss, Herzogenaurach (DE)

(73) Assignee: Schaeffler Technologies AG & Co. KG, Herzogenaurach (DE)

(21) Appl. No.: 18/277,168

(22) PCT Filed: Jan. 27, 2022
(86) PCT No.: PCT/DE2022/100073

§ 371 Date: Aug. 14, 2023

(30) Foreign Application Priority Data
Feb. 15, 2021 (DE) 102021103482.5
Jan. 26, 2022 (DE) 102022101801.6

(51) Int. Cl. C25B 11/02; C25B 11/046

(52) U.S. Cl. CPC C25B 11/02; C25B 11/046

(57) ABSTRACT

An electrolysis plate, in particular for the electrolysis of water, including a rectangular profiled metal sheet which has two long sides and two narrow sides and which has an outer, frame-like connecting region and a profiled region which is located within said connecting region, has a rectangular, non-square basic shape and forms an active area. A flow channel having a longitudinal direction defined by the non-square shape of the profiled region and running parallel to the long sides is delimited by the surface of the profiled region. An embossed pattern of the profiled metal sheet is provided successively in the longitudinal direction of the profiled region at least three times, not overlapping or touching, i.e. spaced apart. Each embossed pattern is formed by at least three individual embossed patterns positioned adjacent to one another, extending in the longitudinal direction and describing a zigzag or undulating shape. Consecutive embossed patterns are separated from one another by a strip-like intermediate section having intermediate profilings, each strip-like intermediate section running parallel to the narrow sides.

### CROSS-REFERENCE TO RELATED APPLICATIONS

This application is the U.S. National Phase of PCT Appln. No. PCT/DE2022/100073, filed Jan. 27, 2022, which claims the benefit of German Patent Appln. No. 102021103482.5, filed Feb. 15, 2021, and German Patent Appln. No. 102022101801.6, filed Jan. 26, 2022 the entire disclosures of which are incorporated by reference herein.

### BACKGROUND

The disclosure relates to an electrolysis plate suitable for use in a hydrogen production system. The disclosure further relates to a method for producing such an electrolysis plate.

EP 1 587 760 B1 discloses an electrolysis cell which comprises a plurality of electrolysis plates. The electrolysis plates are fastened to groove devices within a housing. The housing of the known electrolysis cell has an inlet and an outlet to allow a fluid to flow through. A plurality of disks are arranged in a stacked form in the housing.

An electrolysis plate described in DE 199 56 787 A1 consists of an outer, non-conductive frame and an electrically conductive, bipolar graphite plate mounted therein. Plastic aprons are provided for forcibly guiding electrolyte solutions into the region of an electrolyte feed.

EP 3 725 916 A1 discloses an electrolysis plate intended for use in a device for generating hydrogen, which has an opening for the passage of gas, wherein edges of the opening are covered with an electrically non-conductive material.

A bipolar electrical vessel is known from EP 3 575 442 A1, which is provided for the production of hydrogen. The anode and/or cathode of the vessel is designed as a porous electrode. A membrane of the bipolar vessel is a porous membrane having inorganic components. The device according to EP 3 575 442 A1 is said to be suitable for alkaline electrolysis.

An arrangement of electrochemical cells known from DE 10 2013 225 159 B4, which is provided, for example, for conducting water or aqueous electrolytes, comprises basic elements in the form of flat structures that have a network structure or are formed from a porous material. Several basic elements are arranged one on top of the other, wherein edge regions of the basic elements are connected in a fluid-tight manner with the aid of a filling composite.

Further configuration options for electrochemical systems are disclosed in the documents WO 2019/121947 A1 and WO 2020/030644 A1. The electrochemical systems each comprise multiple separator plates.

### SUMMARY

The disclosure is based on the object of further developing electrolysis plates, which are suitable for hydrogen production, compared to the prior art mentioned, in particular with regard to manufacturing and fluidic aspects.

This object is achieved according to the disclosure by an electrolysis plate having the features of claim 1 that is suitable for use in the electrolysis of water. The object is also achieved by a method for producing such an electrolysis plate according to claim 9. The embodiments and advantages of the disclosure explained below in connection with the production method also apply, mutatis mutandis, to the device, i.e., the electrolysis plate, and vice versa.

An “electrolysis plate” is understood to mean an electrode or electrode plate which is used as an anode or cathode of an electrolysis cell.

The electrolysis plate comprises a rectangular profiled metal sheet having two long sides and two narrow sides, which has an outer, frame-like connecting region and a profiled region lying therein having a rectangular, non-square basic shape, which forms an active area. In particular, the electrolysis plate can be formed exclusively from the profiled metal sheet. The surface of the profiled region delimits a flow channel within a fully assembled electrolysis device, the longitudinal direction LR of which is given by the non-square, rectangular shape of the profiled region and runs parallel to the long sides, wherein an embossed pattern of the profiled metal sheet is provided successively at least three times in the longitudinal direction LR of the profiled region, not overlapping or touching, i.e., while maintaining distances. The respective embossed pattern is formed from at least three individual embossed patterns positioned adjacent to one another, extending in the longitudinal direction LR and describing a zigzag or undulating shape, wherein successive embossed patterns are separated from one another by a strip-like intermediate section having intermediate profilings, and wherein each strip-like intermediate section runs parallel to the narrow sides.

A length H₂ of the rectangular profiled metal sheet is related to a width B₂ of the rectangular profiled metal sheet in particular in the following way: H₂>1.33 B₂ The thickness of a flat profiled metal sheet before the stamping of the embossed pattern and intermediate profilings is preferably 0.5 to 1 mm.

In the region of the active area (=profiled region), i.e., the region of the plate in which chemical reactions take place, the electrolysis plate distributes media flowing past in the longitudinal direction LR evenly through the existing, embossed patterns spaced apart from one another. While there is still a uniform media distribution in the inflow region of an embossed pattern, gaseous media, here hydrogen or oxygen, are produced during the predominantly laminar flow of the medium, here water, past the embossed pattern as a result of the chemical reaction when carrying out the electrolysis. The fluid mixture therefore has inhomogeneities in the outflow region from an embossed pattern, which can manifest themselves in an inhomogeneous water-gas distribution, an inhomogeneous temperature distribution, an inhomogeneous pressure distribution, and the like. A strip-like intermediate section adjoining an embossed pattern serves to mix and homogenize the flowing medium or fluid mixture of liquid and gaseous components. This is achieved by using the intermediate profilings to create turbulent flow and vortices. Thus, a homogeneous or largely homogenized medium or fluid mixture is again present in the inflow region of the adjoining embossed pattern seen in the longitudinal direction LR. This significantly increases the efficiency of the electrolysis process.

A preferred ratio of a length H₉ of an intermediate section in the longitudinal direction LR and a length H₈ of an embossed pattern in the longitudinal direction LR is therefore in the range of H₉/H₈= 1/30 to 1/50. Accordingly, the embossed patterns are designed to be significantly longer in the longitudinal direction LR than are the intermediate sections, which serves to homogenize the media flowing along.

The profiling of the electrolysis plate in the form of repeating embossed patterns spaced apart from one another is also referred to as clustered profiling. The advantages of clustering come into play particularly with large-format disks. The production of electrolysis plates according to the disclosure suitable for electrolysis, in particular the electrolysis of water, is possible in the following steps:
provision of a profiled metal sheet having a rectangular shape, wherein an outer, frame-like region of the profiled metal sheet is defined as a connecting region in accordance with its function in a finished electrolysis cell,
production of the at least three similar embossed patterns spaced apart from one another and the strip-like intermediate sections in the profiled region of the profiled metal sheet enclosed by the connecting region.

The clustering of the embossed patterns is particularly suitable for a profiling in a continuous method. This is, for example, a roll embossing method. Alternatively, the electrolysis plates are manufactured individually using presses. A combination of continuous and discontinuous production technologies for forming the embossed pattern is also possible.

In any case, the clustering of the embossed patterns allows the manufacturing effort to be kept within a moderate range in relation to the size and complexity of the electrolysis plate. As far as the geometry of the embossed pattern is concerned, there is further scope for design, wherein the flow conditions given in the individual case as well as the space available in a stack, which comprises a plurality of electrolysis plates, represent significant boundary conditions. In particular, the embossed patterns can be present in the form of individual zigzag or undulating shaped embossed patterns spaced apart from one another, i.e., connected linear elevations and/or depressions. The aggregate states of the media flowing on the surface of the electrolysis plate also play a role. According to the embodiment according to the disclosure, the embossed patterns therefore describe a zigzag or undulating basic pattern, wherein jagged or undulating lines or arrangements of embossed elements, which overall describe the zigzag or undulating shape, extend in the longitudinal direction LR of the profiled region.

The embossed pattern of the profiled metal sheet is preferably provided successively at least four times in the longitudinal direction LR of the profiled region.

According to the concept according to the disclosure, strip-like intermediate profilings are present between the sections of the profiled region in which an embossed pattern is formed. In particular, a type of bypass can be formed by the intermediate profilings. Irrespective of the geometric design of an intermediate profiling, it can overlap with the two adjacent embossed patterns in the longitudinal direction of the profiled region, which is advantageous in terms of a targeted conduction of medium from one embossed pattern to the next embossed pattern.

The intermediate profilings are preferably designed as discrete elevations which are circular, oval, rectangular, or triangular, or are formed from combinations or groups of such identical or different discrete elevations. In principle, other forms of the intermediate profilings, such as star-shaped, twisted or irregularly shaped discrete elevations are also possible, as long as the laminar flow is broken up and the fluid mixture flowing out of the embossed patterns is swirled. Thus, different discrete elevations can be provided within a strip-like intermediate section. Furthermore, one or more rows of identical or different intermediate profilings can be arranged in the strip-like intermediate section.

In a further preferred embodiment, the intermediate profilings overlap in the longitudinal direction LR of the profiled region with at least one of the two adjacent embossed patterns. The overlapping region is preferably less than 20% of the length H₉ of the strip-like intermediate section in the longitudinal direction LR.

The height h of an intermediate profiling, measured perpendicular to the flat, non-deformed sheet metal surface, is preferably in the range from h=2s to 6s, wherein s=0.5 to 1.0 mm. Each intermediate profiling has a rising and falling flank viewed in the longitudinal direction LR to form a discrete elevation. The rising flank and the falling flank preferably enclose an angle α in the range from 50° to 62°, measured in the longitudinal direction LR. This is particularly preferred for profiled metal sheets made of titanium or stainless steel.

However, metallic profiled metal sheets made of other metals or metal alloys can also be used. Furthermore, the profiled metal sheets used can be coated on one or both sides.

According to a possible development, the profiled region comprises at least one sub-cluster of similar embossed patterns as well as at least one embossed pattern that is upstream or downstream in the longitudinal direction and differs therefrom. The embossed pattern deviating from the sub-cluster in a region upstream or downstream of the sub-cluster in the flow direction can, for example, serve the purpose of calming the flow in the corresponding region. This can be done, for example, by slanting elongated individual embossed patterns, which form an embossed pattern within the sub-cluster at a greater angle to the longitudinal direction of the profiled region than outside of the sub-cluster.

It is also possible for the strip-like intermediate sections between the embossed patterns to be the same or at least partially different in terms of their intermediate profilings. Thus, different discrete elevations can be provided within a strip-like intermediate section.

In the frame-like connecting region, which surrounds the profiled region, there can be a number of openings for the passage of media and/or for the insertion of connection elements, in particular bracing anchors. Otherwise, there are typically seals in the connecting region. For this purpose, groove-shaped recesses are optionally present in the connecting region, which are provided for the insertion of seals. Likewise, seals can contact planar sections of the connecting region. The connecting region can also be held by a separate frame, which is made of plastic or a carbon-plastic composite, for example. In such a case, the seal can also be arranged in the region of this frame.

### BRIEF DESCRIPTION OF THE DRAWINGS

In the following, several exemplary embodiments of the disclosure are explained in more detail by means of a drawing. In the figures, partly simplified:

FIG. 1 shows a first embodiment of an electrolysis plate for the electrolysis of water,

FIG. 2 show a second embodiment of an electrolysis plate,

FIG. 3 shows features of another electrolysis plate in schematic excerpt,

FIG. 4 shows features of still another electrolysis plate in schematic excerpt, and

FIG. 5 shows features of still yet another electrolysis plate in schematic excerpt.

### DETAILED DESCRIPTION

Unless otherwise stated, the following explanations relate to all exemplary embodiments. Parts or contours that correspond to each other or have basically the same effect are marked with the same reference symbols in all figures.

An electrolysis plate, identified as a whole by the reference numeral 1, is provided for use in a hydrogen electrolysis system. With respect to the basic function of the electrolysis plate 1, reference is made to the prior art cited at the outset.

In all of the embodiments, the electrolysis plate 1 is designed as a profiled metal sheet 2 which has a frame-like connecting region 3 and a rectangular profiled region 4 lying in this region 3. The profiled metal sheet 2 is here in particular sheet steel, which can be coated on one or both sides.

A medium, in particular an acidic or alkaline aqueous liquid, flows on the surface of the profiled region 4 essentially in the longitudinal direction LR of the profiled metal sheet 2. The width of the profiled metal sheet 2 is indicated by B₂, the height of the profiled metal sheet 2 by H₂. The profiled region 4 has a width B₄ and a height H₄.

Within the connecting region 3 there are openings 6, which allow media to pass through, and compared to the circular openings 6, smaller bores 5 through which bracing anchors, not shown, can be inserted to mechanically connect numerous electrolysis plates 1 within a stack.

A profiling in the form of a cluster 7 is formed in the profiled region 4. The profiling designed as cluster 7 has an aerodynamic function and also increases the mechanical stability of the electrolysis plate 1 compared to a flat plate. Within the cluster 7, several embossed patterns 8 separated from one another can be seen, each comprising more than three individual embossed patterns 8a, 8b, 8c arranged next to one another, extending in the longitudinal direction LR and describing a zigzag or undulating shape, wherein each embossed pattern 8 overall has a rectangular shape. Two sections of the cluster 7, in which an embossed pattern 8 is located, are each separated from one another by a strip-like intermediate section 9.

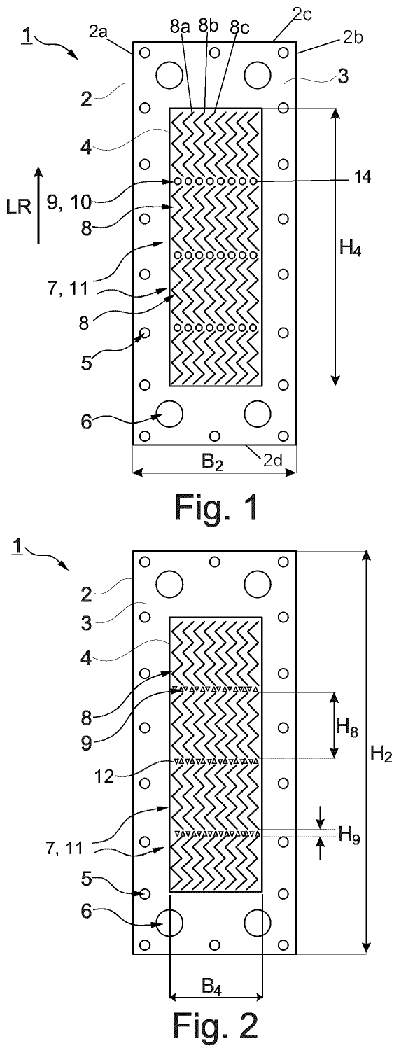

The width of the embossed pattern 8 and the intermediate sections 9 and thus of the entire embossed pattern cluster 7 is identical to the width B₄ of the profiled region 4. The length of each embossed pattern 8 is indicated by H₈, the length of each intermediate section 9 by H₉ (seen in the longitudinal direction LR). The length H₈ is preferably at least thirty times but not more than 50 times the length H₉. There is never an overlap between embossed patterns 8 that follow one another in the longitudinal direction LR, that is to say in the direction of flow. Intermediate profilings 10 are present in the strip-shaped intermediate section 9. A design of the intermediate sections 9 having circular intermediate profilings 14 is shown in FIG. 1, and a design of the intermediate sections 9 having triangular intermediate profilings 12 is shown in FIG. 2. Different configurations of different intermediate sections 9 within one and the same electrolysis plate 1 are also possible.

Both in the embodiment according to FIG. 1 and in the embodiment according to FIG. 2, the embossed pattern 8 is in the form of individual zigzag or undulating shaped embossed elements 8a, 8b, 8c, which are arranged next to each other and extend overall in the longitudinal direction LR.

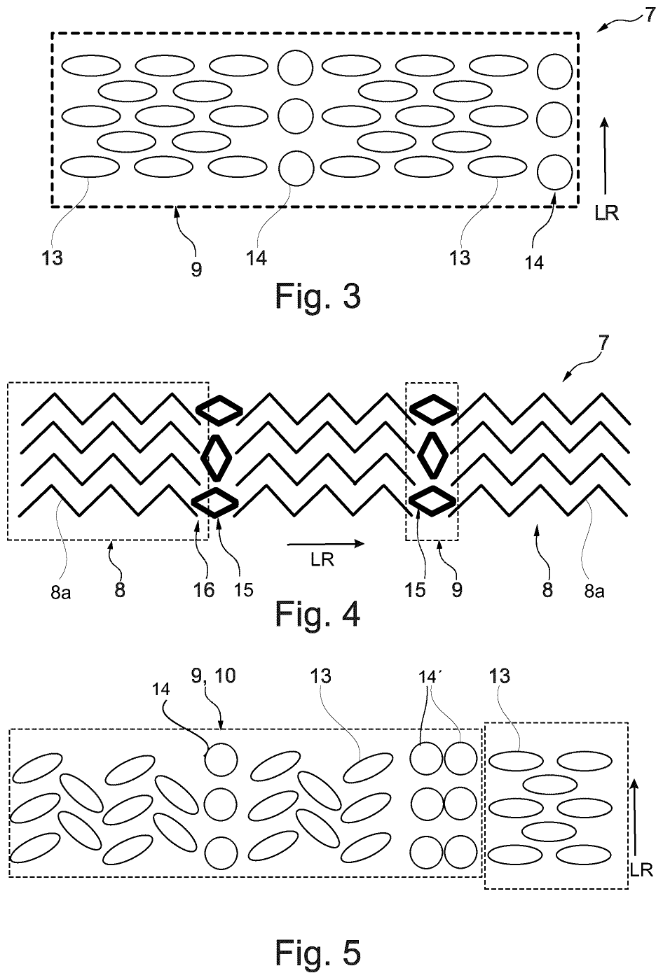

Such circular intermediate profilings 14 are also present in the representation of a strip-shaped intermediate section 9 according to FIG. 3. In this case, the intermediate section 9 is formed from oval intermediate profilings 13 and circular intermediate profilings 14. A particular advantage of this design lies in the good feasibility of forming technology.

The zigzag-shaped embossed patterns 8, which are shown not only in the embodiments according to FIGS. 1 and 2, but in the variant according to FIG. 4, can also be produced using forming technology, wherein sharp-edged transitions within the zigzag pattern are shown idealized in the figures. This also applies to the rectangular, in particular rhombic, intermediate profilings 15 that can be seen in FIG. 4, which form the intermediate profilings 10 here. In the case of FIG. 4, overlapping regions 16 are formed between the embossed patterns 8 and the intermediate sections 9. Some of the rectangular intermediate profilings 15 protrude into a region between two individual embossed patterns 8a, 8b, 8c (compare FIG. 1) of the two adjacent embossed patterns 8 viewed in the longitudinal direction LR.

According to FIG. 5, different intermediate profilings 10 are shown in a strip-like intermediate section 9. In the exemplary embodiment shown, there are oval intermediate profilings 13 on the left in the image, which are designed to be inclined relative to the longitudinal direction LR. Here, the alignment of the oval intermediate profilings 13 alternates, resulting in a zigzag arrangement overall. As can further be seen from FIG. 5, circular intermediate profilings 14 and further inclined oval intermediate profilings 13 follow on the right. Also shown are circular intermediate profilings 14′ arranged in a group of two and to the right thereof oval intermediate profilings 13 that are not inclined relative to the longitudinal direction LR.

The shapes of the intermediate profilings 10, 12, 13, 14, 14′, 15 shown in FIGS. 1 to 5 are only shown as examples and can be varied and/or combined with one another as desired within a strip-like intermediate section 9.

1. An electrolysis plate, comprising: a metal sheet having a rectangular profile with two long sides and two narrow sides including an outer, frame-like connecting region and a profiled region lying in the frame-like connecting region, the profiled region having a rectangular, non-square basic shape forming an active area, a flow channel delimited by a surface of the profiled region, a longitudinal direction of the flow channel extending parallel to the long sides of the metal sheet, and the metal sheet including an embossed pattern provided successively at least three times in a longitudinal direction of the profiled region each embossed pattern including at least three individual embossed patterns positioned adjacent to one another, extending in the longitudinal direction of the profiled region in a zigzag or undulating shape, and wherein successive embossed patterns are separated from one another by a strip-like intermediate section having intermediate profilings, each strip-like intermediate section being arranged to run parallel to the narrow sides of the rectangular profile.

2. The electrolysis plate according to claim 1, wherein the embossed pattern of the metal sheet is provided successively at least four times in the longitudinal direction of the profiled region.

3. The electrolysis plate according to claim 1, wherein the intermediate profilings include discrete elevations which are circular, oval, rectangular, or triangular, or are formed from combinations or groups of such identical or different elevations.

4. The electrolysis plate according to claim 1, wherein the intermediate profilings overlap in the longitudinal direction of the profiled region having at least one of the two adjacent embossed patterns.

5. The electrolysis plate according to 1, wherein a ratio of a length of an intermediate section in the longitudinal direction of the profiled region and a length of an embossed pattern in the longitudinal direction of the profiled region is in the range from 1/30 to 1/50.

6. The electrolysis plate according to 1, wherein the profiled region includes at least one sub-cluster of similar embossed patterns and at least one embossed pattern upstream or downstream in the longitudinal direction of the profiled region that differs therefrom and/or that the intermediate sections between the embossed patterns differ at least partially with regard to their intermediate profilings.

7. The electrolysis plate according to claim 1, wherein a plurality of openings are present in the frame-like connecting region for the passage of media and/or for the insertion of connecting elements.

8. An electrolysis system comprising: electrolysis plate, wherein the electrolysis plate includes a metal sheet having a rectangular profile with two long sides and two narrow sides including an outer, frame-like connecting region and a profiled region lying in the frame-like connecting region, the profiled region having a rectangular, non-square basic shape forming an active area, a flow channel delimited by a surface of the profiled region, a longitudinal direction of the flow channel extending parallel to the long sides of the metal sheet, and the metal sheet including an embossed pattern provided successively at least three times in a longitudinal direction of the profiled region, each embossed pattern including at least three individual embossed patterns positioned adjacent to one another, extending in the longitudinal direction of the profiled region in a zigzag or undulating shape, and wherein successive embossed patterns are separated from one another by a strip-like intermediate section having intermediate profilings, each strip-like intermediate section being arranged to run parallel to the narrow sides of the rectangular profile.

9. A method for producing an electrolysis plate comprising:
providing a profiled metal sheet having a rectangular shape, an outer, frame-like region of the profiled metal sheet being defined as a connecting region and a profiled region lying in the connecting region, the profiled region having a rectangular, non-square basic shape forming an active area, a flow channel delimited by a surface of the profiled region, a longitudinal direction of the flow channel extending parallel to the long sides of the metal sheet,
producing in the profiled region at least three successive embossed patterns in a longitudinal direction of the profiled region, each embossed pattern including at least three individual embossed patterns having a zigzag or undulating shape, and wherein successive embossed patterns are separated from one another by a strip-like intermediate section having intermediate profilings, each strip-like intermediate section being arranged to run parallel to the narrow sides of the rectangular profile.

10. The method according to claim 9, wherein the embossed patterns are produced in a continuous method.

11. The electrolysis system according to claim 8, wherein the embossed pattern of the metal sheet is provided successively at least four times in the longitudinal direction of the profiled region.

12. The electrolysis system according to claim 8, wherein the intermediate profilings include discrete elevations which are circular, oval, rectangular, or triangular, or are formed from combinations or groups of such identical or different elevations.

13. The electrolysis system according to claim 8, wherein the intermediate profilings overlap in the longitudinal direction of the profiled region having at least one of two adjacent embossed patterns.

14. The electrolysis system according 8, wherein a ratio of a length of an intermediate section in the longitudinal direction of the profiled region and a length of an embossed pattern in the longitudinal direction of the profiled region is in the range from 1/30 to 1/50.

15. The electrolysis system according to 8, wherein the profiled region includes at least one sub-cluster of similar embossed patterns and at least one embossed pattern upstream or downstream in the longitudinal direction of the profiled region that differs therefrom and/or that the intermediate sections between the embossed patterns differ at least partially with regard to their intermediate profilings.

16. The electrolysis system according to claim 8, wherein a plurality of openings are present in the frame-like connecting region for the passage of media and/or for the insertion of connecting elements.
